(19) United States
(12) Patent Application Publication
(10) Pub. No.: US 2005/0007566 A1
(43) Pub. Date: Jan. 13, 2005

(54) Animation viewer

(76) Inventors: David Gifford Burder, London (GB); Michael Christopher Hutley, Hampton (GB); David Potts, London (GB)

Correspondence Address: Benita J. Rohm;ROHM & MONSANTO, P.L.C., Suite 1525, 660 Woodward Ave., Detroit, MI, 48226, US

(21) Appl. No.: 10/703,182

(22) Filed: Nov. 6, 2003

(30) Foreign Application Priority Data
Nov. 6, 2002 (GB) 0225852.3

(51) Int. Cl. G03B 21/00

(52) U.S. Cl. 353/120

(57) ABSTRACT

A viewing device having a series of images, the images arranged to be viewed through a viewing means, the viewing means having a series of lens, the lens and images being provided in a common geometrical configuration and, for viewing, fixed with respect to one another. Relative movement between the viewing device and the observer's eye allows the sequential viewing of the images through the lens to provide an animation effect.

### BACKGROUND OF THE INVENTION

1. Field of the Invention

The invention which is the subject of this application relates to an animation viewer of the type which, when viewed in a particular manner, allows the viewing of a series of drawings, photographs, or other viewable material, to provide an animated effect.

2. Description of the Prior Art

Animated viewers are well known devices for displaying one or more frames of material which have been created by a graphic or a photographic means. One known type of viewer is an animation viewer that uses the physiological effect known as persistence of vision, to enable the observer to view a series of shuttered adjacent images in quick succession thereby giving the effect of viewing a scene in motion.

Animation viewers of this type require relative movement between the images, and the lens through which the images are viewed and this is normally achieved by the use of a mechanical or optical device to intermittently shutter and move each of a series of images from, for example, a movie film, past a lens relative to the observer. The observer then sees the effect of continuous motion due to the effect of the persistence of vision. A problem with this form of device is that multiple components are required and relatively precise mechanisms need to move the film relative to the optical system in order for effective results to be seen. These problems can mean that the cost of such devices can become excessive and thereby limit the commercial opportunities for the sam. Such devices also need the viewable material which forms the animation sequences, to be contained within the body of the viewer in order to contain and protect the same and also allow the looping of the piece of movie film, if that is the form of the viewable material.

The aim of the present invention is to provide apparatus and a method which eliminates or reduces the need for moving parts and therefore the only motion required is for the observer to move the viewing device across their eyes, or to move one's head with respect to the viewing device.

### SUMMARY OF THE INVENTION

In a first aspect of the invention there is provided a viewing device by which a series of images can be viewed, in succession, to provide an animation effect to the observer wherein said viewing device comprises the series of images in a pre-selected configuration and a viewing means through which the observer views said images, said viewing means and images mutually fixed in position with respect to each other when the images are viewed and relative movement between the viewing device and observer produces the animation effect.

Typically the viewing means comprises a series of lenses, typically micro lens. The move from viewing through one micro lens to another acts as a shutter mechanism and gives effective animation without, or with minimum, blurred carryover effects of one image to the next.

In one embodiment the viewing means includes a component in the form of a row of small lenses (micro lenses), behind which is located the viewing material comprising a series of images, each image typically placed at the same spacing as the lenses. Typically the viewing means are spaced from the images by the focal length of the lenses.

In one embodiment, the images can be fixed in position permanently or a set of images can be selectively inserted into the viewer for viewing, or alternatively the viewing means are provided separately to the images such that the viewing means can be placed in position on a sheet material which includes a series of images to be viewed.

Typically, one lens is provided for each frame or image of animation and this is sufficient to give a satisfactory animation effect. Therefore, in one embodiment, if the lenses are of 5 mm diameter and the images are spaced at 5 mm, a 100 mm long viewing device would play back 20 frames of animation.

In one embodiment the images are provided in a linear strip and the viewing means are in a linear line. Alternatively, and for more compact uses, a rotary configuration may be adopted for both the images and the viewing means or indeed any of a range of suitable geometrical shapes could be used.

By moving the viewing device with respect to the observer, a fully animated scene may be observed from the series of images. Alternatively, the observer can move his or her head with respect to the viewing device, and they will observe animation with the viewing device remaining still.

Differing series of images can be inserted into the viewing device to enable new animated sequences to be observed. In one form the images can be printed on an insert, or alternatively they can be printed within the pages of a publication, and the viewing means can be placed as instructed at differing locations on said page or pages to obtain differing animation effects.

Further embodiments of the above viewing device include a duplication of images within the series of images in order to clarify a complex animation by effectively slowing down the speed of animation without introducing any jerkiness in animation.

Another option is to arrange for the images to be provided as suitable adjacent stereoscopic pairs, so that the animation can be viewed in 3-D if both eyes are open.

Another embodiment of the invention permits viewing of alternative sequences contained in a series of images, and this is achieved by printing several sets of images, one row above the other, so that repositioning of the print will allow another set of animation to be seen behind the viewing means.

Similarly, the viewing means may comprise more than one viewing area such that, for example, a series of rows of micro lenses can be included so that by repositioning the viewing device in relation to the eye, different image sequences may be viewed from sets of images positioned at different locations which match the viewing locations.

Another embodiment of the invention is for 3-D stereoscopic animation, and this is achieved by arranging that the adjacent images are stereoscopic pairs, so that the left eye sees the left view whilst the right eye sees the corresponding right view of the animation, thereby enabling the animation to be seen in 3-D.

In one embodiment a sound device may be positioned within the viewing device or on the image strip. In one embodiment the sound device is activated by the action of inserting a new animation strip or by the user.

In a further aspect of the invention there is provided a one-piece viewing device, said viewing device including a series of images and a viewing means through which said images are viewed by an observer and by which animation is achieved by relative movement between the observer and the viewing device.

In one embodiment, the viewing device is provided in a form with the viewing means spaced by the focal length of the viewing means from the series of images. Typically, the viewing means comprises a series of lens with the width of each of the lens matching the spacing of each of the images.

In a further embodiment of the invention, the viewing device is provided to be movable between a relatively flattened form and an erected in-use form. In one embodiment, in a flattened form, the viewing means lie substantially parallel with and in contact with the sheet material on which the images are provided and relative movement between the viewing means and the images allows the viewing means to be positioned at a spaced distance from the images. Typically the spaced distance is equal to the focal length of the lenses of the viewing means.

In one embodiment, the viewing means and images are provided on sheet material with fold lines provided intermediate the viewing means and the images so as to allow the relative movement about the fold lines of the viewing means and images between the erected and flattened conditions.

In one embodiment, the sheet material includes at least one aperture to allow sufficient light to pass into the cavity defined between the viewing means and the series of images when in the erected condition.

### BRIEF DESCRIPTION OF THE DRAWING

Comprehension of the invention if facilitated by reading the following detailed description of a specific embodiment of the invention is now described, wherein:

FIG. 1 illustrates a row of images for use in accordance with the invention;

FIG. 2 illustrates in perspective view a viewing means for the images of FIG. 1 in accordance with the invention;

FIG. 3 illustrates a side elevation of the viewing means and images of FIGS. 1 and 2;

FIGS. 4a-I illustrate a plan view of FIG. 3; and

FIGS. 5 and 6 illustrate one specific embodiment of the invention.

### DETAILED DESCRIPTION

Referring firstly to FIG. 1 there is illustrated a series of images 2-18, provided in this case as a strip, although it should be appreciated that this need not be the case and any of a range of suitable geometrical shapes can be used.

In this case each of the images depicts a person 20 in various physical positions.

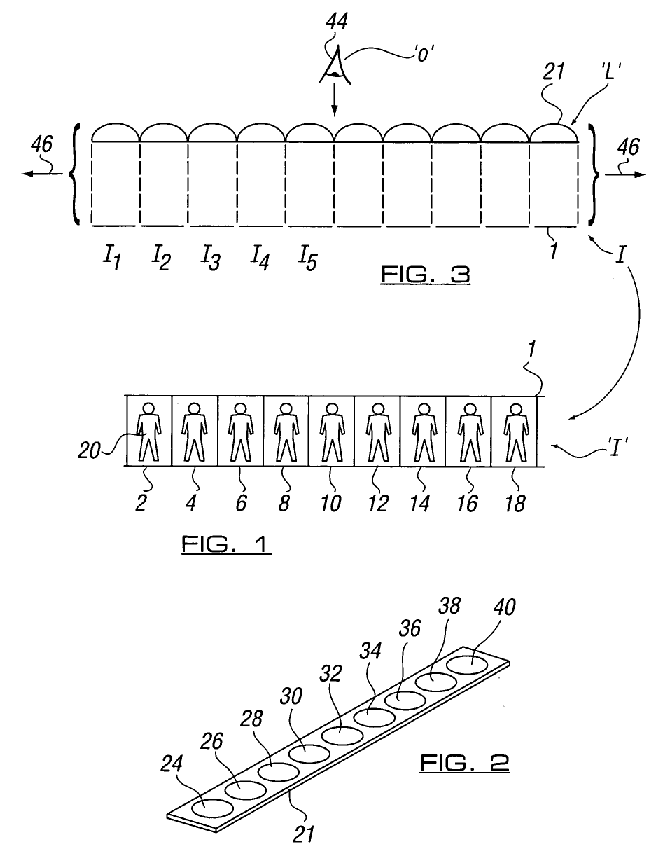

FIG. 2 illustrates a viewing means 21 in accordance with the invention in the form of a plurality of side by side lens 24-40 and it will be appreciated that typically the same number of lens as images are provided and in matching geometrical configuration to the images. In this case the viewing means is provided as a single piece unit with the lenses molded as one unit.

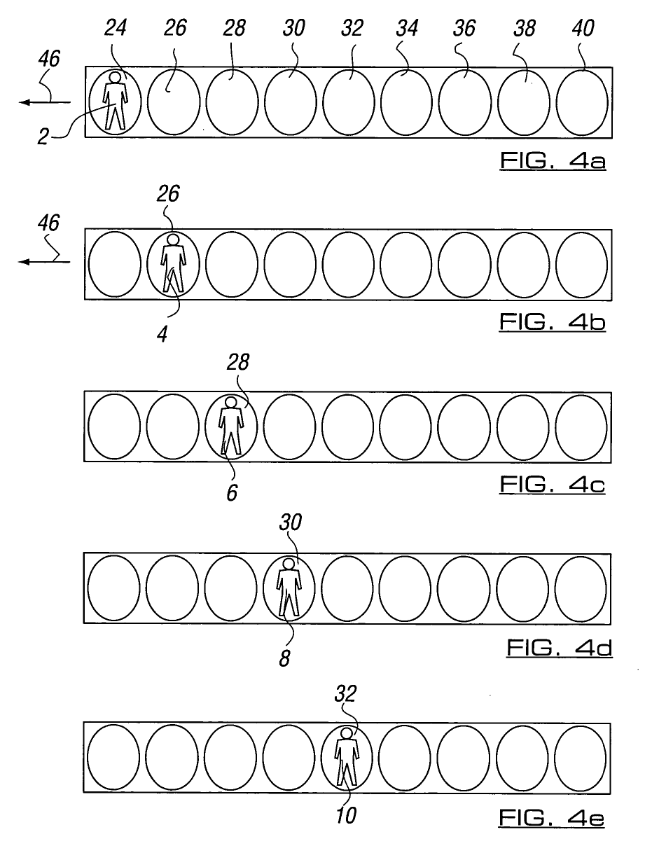

Turning now to FIG. 3 the images 2-18 and viewing means 21 are shown in position for viewing with a user's eye 44. In this case there is shown a row of 5 mm diameter lenses in front of the images which are also spaced at 5 mm.

The strip of images 2-18 is temporarily fixed within the viewer but may be replaced with other strips to allow the viewing of different animated images. The observer's eye 44 is at position O. In this embodiment as the images and viewing means are provided in a linear strip, the viewing device 42 in combination is pulled across left to right to left, as indicated by arrows 46, for the animation to be observed by the user's eye 44. If a rotary configuration was used for the viewing means and images a rotary movement of the viewing device would be required. The series of images 1 and the viewing means 21 are fixed with respect to each other.

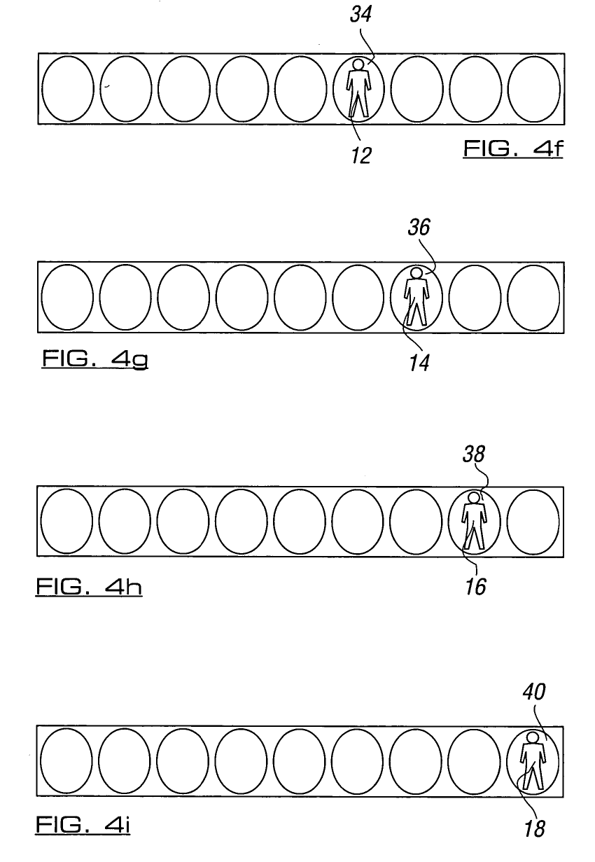

FIGS. 4a shows the same strip of images 2-18 but from a plan view. Typically the longer the viewer, then the more image frames can be included in the animated sequence. Referring to this FIGS. 4a-4i the act of swiping the viewer with its strip of images across the eyes gives true animation, as the jump from lens to lens acts as a shutter device to eliminate blurring between frames and allows the animation effect to be created. For example when the eye 44 is above lens 24 the image 2 is the only one viewed by the eye as shown in FIG. 4a. When the viewing device is moved as indicated by arrow 46 and the eye 44, remaining in position, is above lens 26, it is only the image 4 which can be seen by the eye as shown in FIG. 4b. Thereafter the sequence of viewing continues by movement of the viewing device for the further lens and images as shown in FIGS. 4c -4i, as the viewing device is moved in accordance with the arrow 46 in a lens-by-lens stepwise manner.

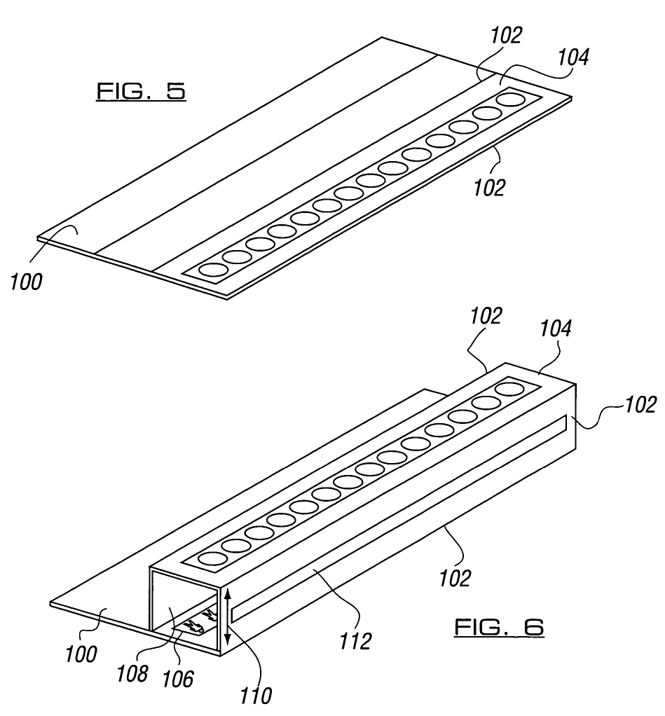

FIGS. 5 and 6 illustrate one particular embodiment of the invention. In FIG. 5, the viewing device is shown in a flattened stored form and in FIG. 6 is shown in an erected in-use position.

In both cases, the viewing device 100 is formed by sheet material in the form of card in this example, with fold lines 102, which allow the relative movement between the viewing means 104 and the series of images 106 between the flattened condition shown in FIG. 5 and the erected condition shown in FIG. 6. In the erected condition, a cavity 108 is formed between the viewing means and the series of images so as to allow the focal length 110 of the lenses of the viewing means to be the distance between the viewing means and the series of images. Also provided is an aperture 112 which allows light to enter into the cavity 108.

When in the flattened condition, the device can be provided to be stored prior to purchase or provision to the observer and thereafter may also be stored when not in use thereby improving the attractiveness of the device and also making the device relatively cheap to manufacture. It is therefore envisaged that the device is particularly suited to the provision of commercial purposes such as, for example, free giveaways, marketing devices or the like.

Although the invention has been described in terms of specific embodiments and applications, persons skilled in the art may, in light of this teaching, generate additional embodiments without exceeding the scope or departing from the spirit of the claimed invention. Accordingly, it is to be understood that the drawing and description in this disclosure are proffered to facilitate comprehension of the invention, and should not be construed to limit the scope thereof.

1. A viewing device by which a series of images can be viewed, in succession, to provide an animation effect to the observer wherein said viewing device comprises the series of images in a pre-selected configuration and a viewing means through which the observer views said images, said viewing means and images mutually fixed in position with respect to each other when the images are viewed and relative movement between the viewing device and the observer produces the animation effect.

2. A viewing device according to claim 1 wherein the viewing means comprises a series of lenses in the same configuration as the series of images.

3. A viewing device according to claim 2 wherein the lenses are micro lens.

4. A viewing device according to claim 1 wherein the viewing means lies between the observer's eye and the series of images to be viewed.

5. A viewing device according to claim 1 wherein the viewing means comprises a series of lenses and the spacing of the images in the series of images matches the width of each of the lenses.

6. A viewing device according to claim 1 wherein the viewing means are spaced from the series of images by a length which is equivalent to the focal length of the lenses which form the viewing means.

7. A viewing device according to claim 1 wherein the images to be viewed are fixed permanently in position.

8. A viewing device according to claim 1 wherein the images to be viewed are provided as a set, said set selectively positioned within the viewing device for viewing

9. A viewing device according to claim 1 wherein the viewing means are separately movable prior to viewing with respect to the series of images so as to bring the viewing means into position for viewing said images.

10. A viewing device according to claim 1 wherein the viewing means comprise a series of lens and one lens is provided for each image on the series of images to be viewed.

11. A viewing device according to claim 1 wherein images are provided in a linear strip and the viewing means are provided in a linear line.

12. A viewing device according to claim 1 wherein the images are provided in a rotary configuration and the viewing means are provided in the same rotary configuration.

13. A viewing device according to claim 1 wherein the animation is achieved by relative movement between the observer's eye and the viewing device.

14. A viewing device according to claim 1 wherein at least some of the images in the series of images are duplicated within said series.

15. A viewing device according to claim 1 wherein images within the series of images are provided as adjacent stereoscopic pairs.

16. A viewing device according to claim 1 wherein a plurality of series of images are available to be viewed by a plurality of viewing means, said viewing means and sets of images provided at matching locations.

17. A viewing device according to claim 1 wherein a plurality of series of images are provided to be viewed through a viewing means, said viewing means being movable with respect to the differing series of images to allow the selective viewing of one of said series of images at any given time.

18. A viewing device according to claim 1 wherein the viewing device is provided to be movable between a relatively flattened form and an erected in-use form.

19. A viewing device according to claim 18 wherein, in the flattened form, the viewing means lie substantially parallel with the sheet material on which the images are provided and relative movement between the viewing means and the images moves the device to the erected form.

20. A viewing device according to claim 18 wherein the viewing means and images are provided in sheet material with fold lines provided intermediate the same so as to allow the relative movement to bring the viewing means and images into an in-use position.

21. A viewing device according to claim 1 wherein the viewing device includes at least one aperture to allow light to pass into a cavity which is defined between the viewing means and the series of images when in the erected condition.

22. A one-piece viewing device, said viewing device including a series of images and a viewing means through which said images are viewed by an observer and by which animation is achieved by relative movement between the observer and the viewing device.
